(19) United States
(12) Patent Application Publication
(10) Pub. No.: US 2011/0121212 A1
(43) Pub. Date: May 26, 2011

(54) CANDLE FLAME ACTIVATED DYNAMIC CANDLE HOLDER

(76) Inventor: Tsan-Yao CHEN, Taipei (TW)

(21) Appl. No.: 12/626,457

(22) Filed: Nov. 25, 2009

(51) Int. Cl. H01J 40/02

(52) U.S. Cl. 250/554

(57) ABSTRACT

A candle flame activated dynamic candle holder is revealed. The dynamic candle holder includes a candle holder, at least one optical sensor and a dynamic display device. A receptacle for receiving a candle is arranged on a top of the candle holder and the optical sensor is disposed outside the receptacle so as to receive candle light for being activated. The dynamic display device is composed of a circuit board, a motor and an ornament. When the candle is lighted, the optical sensor is turned on by light from the candle and then is electrically connected with the circuit board so as to drive the motor to operate. Thus the ornament is moved and displayed dynamically. When the candle is out, the motor stops working.

### BACKGROUND OF THE INVENTION

The present invention relates to a candle flame activated dynamic candle holder, especially to a candle flame activated dynamic candle holder in which an optical sensor is turned on by lighting a candle and is electrically connected to a circuit board so as to drive a motor that moves an ornament. Thus the ornament is driven to be moved and displayed dynamically.

A common small candle holder used as indoor ornaments provides lighting as well as decorative effects so as to enrich the atmosphere. However, traditional candle holder such as a candle cup only provides lighting when the candle is lighted. Without the candle, the candle holder can only load the candle and provide static decorative effects. There is no direct connection between the candle holder and the lighting of the candle. Moreover, there is another kind of water light candle. A magnetic part is driven by an external motor and a magnetic moving part in a water light is further driven to rotate so as to generate a swirl flow in a liquid in the water light. Moreover, used in combination with a blinking lighting element, the water light candle provides both visual effects of blinking and liquid swirl. The device further includes a power switch for activation of the motor and the lighting element. This is a common way to activate the device, lack of novelty and interesting.

### SUMMARY OF THE INVENTION

Therefore it is a primary object of the present invention to provide a candle flame activated dynamic candle holder that includes a candle holder, at least one optical sensor and a dynamic display device. The candle holder is disposed with a receptacle for loading a candle such as a common candle cup on top thereof. The optical sensor such as an infrared (IR) optical sensor for receiving candle light is disposed on an outer surface of the receptacle. The dynamic display device consists of a circuit board, a motor, and an ornament. The circuit board is electrically connected with the optical sensor and the motor. The motor drives the ornament to move. When the candle is lighted, the optical sensor is turned on by candle light and then the optical sensor is electrically connected with the circuit board so as to drive the motor to rotate synchronously. Thus the ornament is moved and displayed dynamically. When the candle is blown out, the motor stops working.

It is another object of the present invention to provide a candle flame activated dynamic candle holder in which the ornament of the dynamic display device is further mounted in a transparent container, moved by the motor and displayed through the transparent container.

It is a further object of the present invention to provide a candle flame activated dynamic candle holder in which the receptacle for loading a candle is arranged at a top surface of the transparent container.

### BRIEF DESCRIPTION OF THE DRAWINGS

FIG. 1 is a perspective view of an embodiment according to the present invention;

FIG. 2 is an explosive view of the embodiment in FIG. 1;

FIG. 3 is a perspective view of another embodiment according to the present invention;

FIG. 4 is an explosive view of the embodiment in FIG. 3.

### DETAILED DESCRIPTION OF THE PREFERRED EMBODIMENT

### Embodiment One

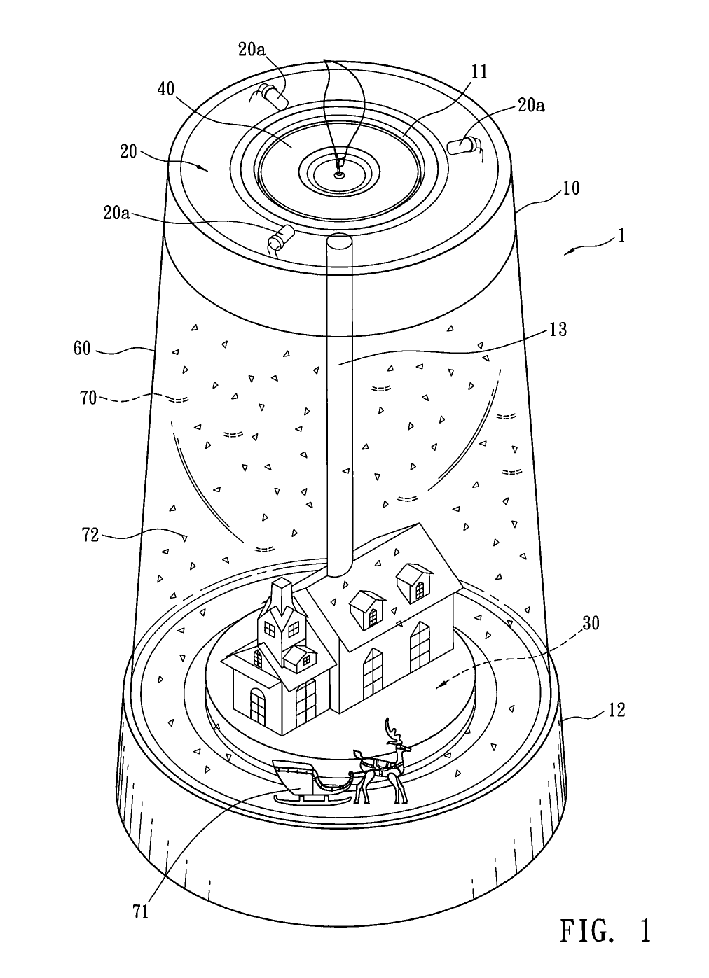

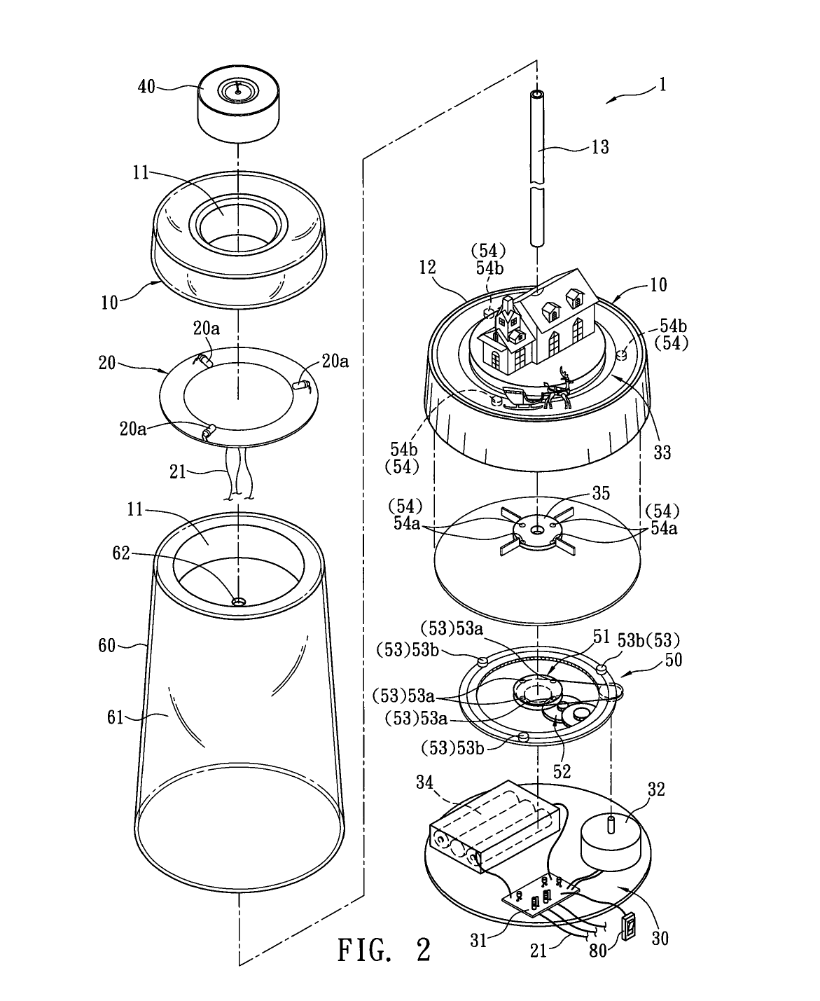

Refer from FIG. 1 to FIG. 2, a candle flame activated dynamic candle holder 1 according to the present invention includes a candle holder 10, an optical sensing member 20 and a dynamic display device 30. There is no limit on the style of the candle holder 10. A receptacle 11 with an opening facing forward for loading a candle 40 such as a candle cup is arranged on top of the candle holder 10 while a base 12 is disposed on bottom of the candle holder 10. A tubular member 13 is arranged between the receptacle 11 and the base 12 and is connected with the base 12.

The optical sensing member 20 consists of a circuit board (not shown in figure) and at least one optical sensor 20a such as an infrared (IR) optical sensor. The optical sensors 20a are disposed around the receptacle 11 so as to receive candle light emitting from a candle 40. The optical sensor 20a is connected with an electrical wire 21 that passes through the tubular member 13 so as to connect with the dynamic display device 30. Thus while receiving candle light form the candle 40, the optical sensor 20a sends an activation signal to the dynamic display device 30 by the electrical wire 21.

The dynamic display device 30 is composed of a circuit board 31, a motor 32 and an ornament 33. The circuit board 31 is electrically connected with the optical sensor 20a by the electrical wire 21 and is also electrically connected with the motor 32. The motor 32 is driven to rotate by a power source 34. There is no limit on the power source 34. It can be a battery set or an external power supply. The dynamic display device 30 further includes an impeller 35. A shaft end of the motor 32 is connected with a driving member 50 so as to drive and move the ornament 33. There is no restriction on the structure of the driving member 50. As shown in FIG. 2, the driving member 50 consists of a pulley set 51, a gear set 52 moving along with the pulley set 51. Moreover, the driving member 50 includes at least one magnetic element 53 and at least one magnetic moving element 54 corresponding to the magnetic element 53. When the magnetic element 53 is driven, the magnetic moving element 54 is also driven to move synchronously due to magnetic effect. For example, a set of magnetic element 53a such as four magnetic elements 53 is arranged at the pulley set 51 while a set of magnetic moving element 54a such as four magnetic moving elements 54 is disposed on the impeller 35 correspondingly. Or a set of magnetic element 53b such as three magnetic elements 53 is arranged at the gear set 52 and a set of magnetic moving element 54b such as three magnetic moving elements 54 is disposed on the ornament 33.

Refer to FIG. 2, the present invention further includes a switch 80 that is connected with the circuit board 31 of the dynamic display device 30. By shifting ON/OFF modes of the switch 80, the motor 32 is controlled to start or stop rotating.

### Embodiment Two

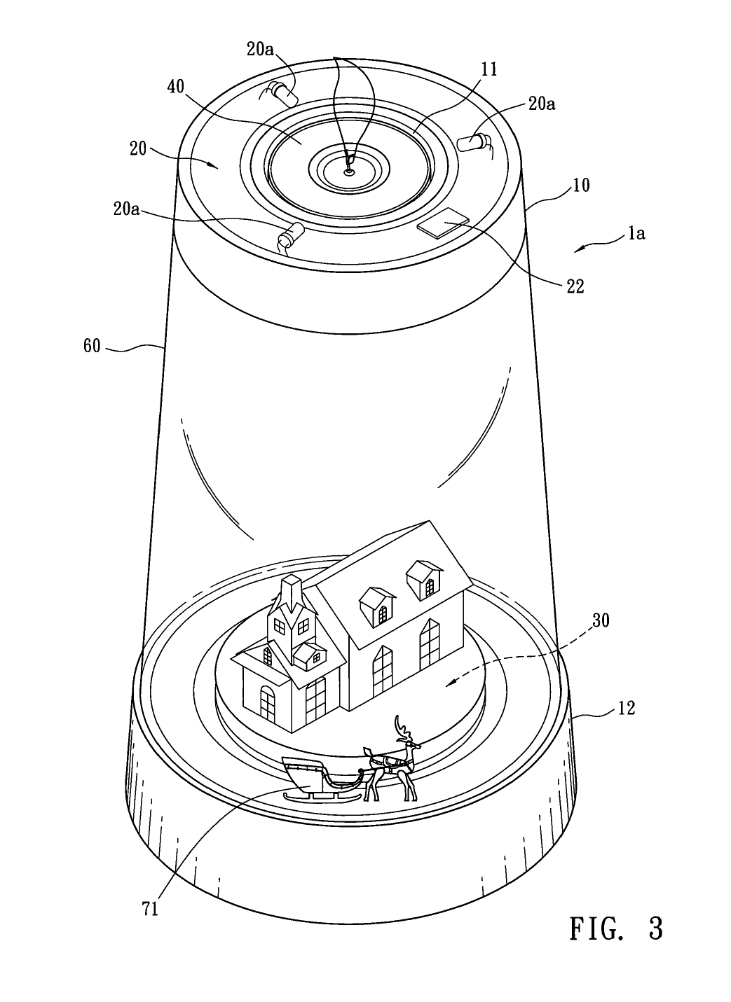

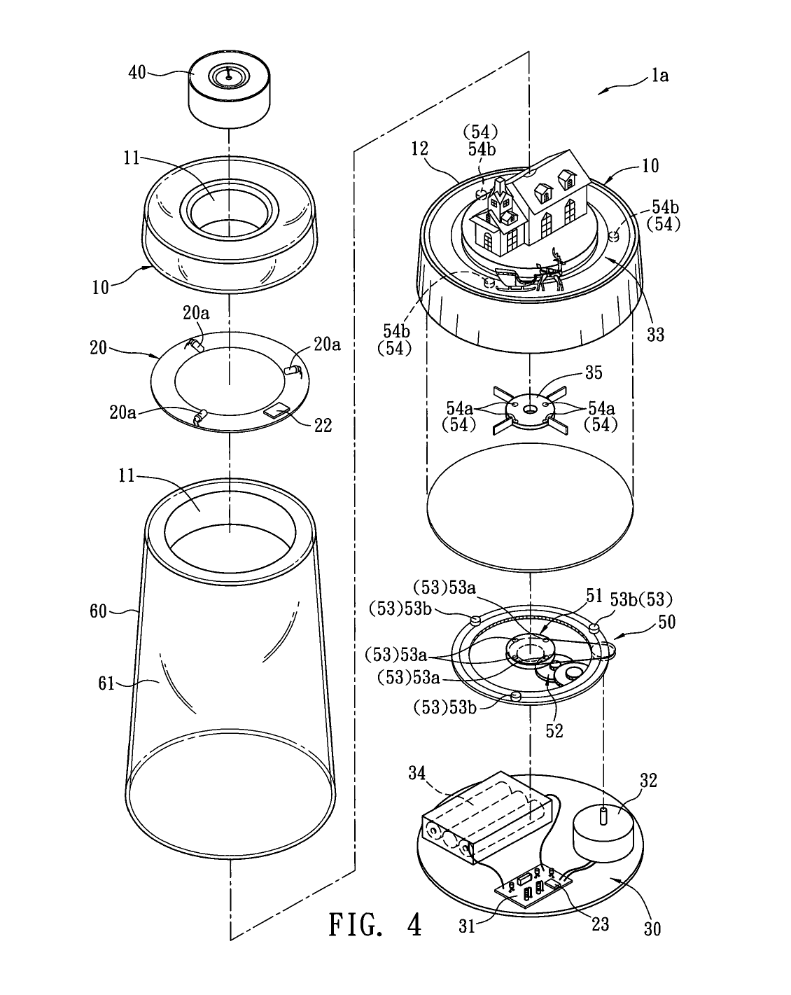

Refer to FIG. 3 and FIG. 4, the different between a candle holder 1a in this embodiment and that of the above embodiment is in that: the optical sensor 20a of the embodiment one is connected with the dynamic display device 30 by the electrical wire 21 passing through the tubular member 13 (as shown in FIG. 2) while an optical sensor 20a of this embodiment sends an activation signal to a dynamic display device 30 in a wireless way. The optical sensing member 20 of this embodiment is disposed with a transmitter 22 such as an infrared (IR) transmitter so as to transmit an activation signal to the dynamic display device 30 while a receiver 23 such as an infrared (IR) receiver is arranged at the circuit board 31 of the dynamic display device 30 so as to receive the activation signal from the transmitter 22.

The candle holders 1, 1a of the present invention further includes a transparent container 60 having a closed space 61 for receiving an ornament 33 or filled with an aqueous liquid 70, as shown in FIG. 1. The receptacle 11 is disposed on a top surface of the transparent container 60 so as to receive the candle cup with the candle 40. Refer to FIG. 2m a through hole 62 is mounted on a bottom surface of the receptacle 11. One end of the tubular member 31 is connected with the through hole 62 while the other end thereof is connected with the base 12. As shown in FIG. 2 and FIG. 4, in the driving member 50, the part disposed with the magnetic element 53 such as the pulley set 51 and the gear set 52 is arranged outside the transparent container 60 while the part with magnetic moving element 54 such as the impeller 35 and the ornament 33 is arranged inside the transparent container 60. Thus when the magnetic element 53 outside the transparent container 60 is driven to move, the magnetic moving element 54 in the transparent container 60 is also driven to move synchronously by the magnetic effect because the magnetic force can penetrate through various materials. Therefore, there is no need to arrange a waterproof packing around the driving member 50 for preventing liquid leakage or infiltration.

When the candle 40 is lighted, the optical sensor 20a is switched on by candle light and then the optical sensor 20a is electrically connected with the circuit board 31 of the dynamic display device 30 in a wired (embodiment one) or wireless way (embodiment two) so as to drive the motor 32. Through the magnetic element 53 of the driving member 50, the motor 32 further drives the magnetic moving element 54 to move synchronously but the driving way is not limited to this type. Thus the ornament 33 is displayed through the transparent container 60 dynamically. For example, a snow vehicle moves around a center of the base 12 or a plurality of floating fragments 72 are flowing inside the transparent container 60 by the quick rotation of the impeller 35. When the candle 40 is blown out, the optical sensor 20a receives no light so that the motor 32 stops rotation.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A candle flame activated dynamic candle holder comprising:
a candle holder arranged with a receptacle for loading a candle;
an optical sensor for receiving light from the candle to be activated and being disposed on an outer surface of the receptacle; and
a dynamic display device disposed on a base on a bottom of the candle holder and having a circuit board, a motor and an ornament wherein the circuit board is turned on by the optical sensor and is electrically connected to the motor so that the motor is driven by a power to make the ornament move;
wherein the optical sensor is activated by the light from the candle and is electrically connected with the circuit board so as to drive the motor to operate and move the ornament dynamically when the candle is lighted; the motor stops working when the candle is extinguished.

2. The device as claimed in claim 1, wherein the optical sensor is an infrared (IR) optical sensor.

3. The device as claimed in claim 1, wherein a connected tubular member is arranged between the base on the bottom of the candle holder and the receptacle.

4. The device as claimed in claim 3, wherein the optical sensor is connected with the dynamic display device by an electrical wire that passes through the tubular member so that the optical sensor sends an activation signal to the circuit board for driving the motor to operate.

5. The device as claimed in claim 1, wherein the optical sensor is disposed with a transmitter for transmitting an activation signal while the circuit board of the dynamic display device is arranged with a receiver for receiving the activation signal from the transmitter so as to activate the motor to rotate.

6. The device as claimed in claim 5, wherein the transmitter is an infrared (IR) transmitter and the receiver is an infrared (IR) receiver.

7. The device as claimed in claim 1, wherein a shaft end of the motor is connected with a driving member so as to drive and move the ornament.

8. The device as claimed in claim 7, wherein the driving member includes at least one pulley set and/or at least one gear set.

9. The device as claimed in claim 1, wherein the candle holder further includes a transparent container in which a closed space for receiving an ornament or filled with an aqueous liquid is formed and the receptacle is disposed over the transparent container.

10. The device as claimed in claim 7, wherein the driving member includes at least one magnetic element and at least one magnetic moving element, corresponding to each other while the magnetic moving element is moved synchronously due to magnetic effect when the magnetic element is driven.

11. The device as claimed in claim 9, wherein the magnetic element is arranged outside the transparent container and the magnetic moving element is disposed in the transparent container.

12. The device as claimed in claim 10, wherein the magnetic element is arranged outside the transparent container and the magnetic moving element is disposed in the transparent container.

13. The device as claimed in claim 1, wherein the candle holder includes a switch that is connected with the circuit board of the dynamic display device and the motor is controlled to start or stop rotating by operation of the switch.
